(19) United States
(12) Patent Application Publication
(10) Pub. No.: US 2013/0003045 A1
(43) Pub. Date: Jan. 3, 2013

(54) OPTICAL ABSORPTION SPECTROSCOPY WITH MULTI-PASS CELL WITH ADJUSTABLE OPTICAL PATH LENGTH

(76) Inventor: Steven Wilkins, Hotwells (GB)

(21) Appl. No.: 13/577,873

(22) PCT Filed: Feb. 8, 2011
(86) PCT No.: PCT/GB11/00167

§ 371 Date: Sep. 18, 2012

(30) Foreign Application Priority Data
Feb. 9, 2010 (GB) 1002200.2
Jul. 30, 2010 (GB) 1012819.7

(51) Int. Cl. G01J 3/42

(52) U.S. Cl. 356/51; 356/402; 356/413

(57) ABSTRACT

An optical absorption spectroscopy apparatus comprises a light source, a detector for detecting an optical absorption spectrum of light transmitted from the source through a sample volume and one or more reflectors for reflecting the transmitted light multiple times through the sample volume. An adjuster device is provided for adjusting at least one optical element so as to vary the path length of the transmitted light by controlling the number of times the light is reflected through the sample volume. Drive means is provided for driving the adjuster device, so enabling the detector to detect the transmitted light at a range of different path lengths.

### FIELD OF INVENTION

The present invention relates to an apparatus for optical absorption spectroscopy and a method of optical absorption spectroscopy. In particular, but not exclusively, the invention relates to apparatus and methods for detecting the presence and/or concentration of one or more substances using ultraviolet, visible or infrared light, by differential or conventional optical absorption spectroscopy. The detected substances may be fluids (gases or liquids), for example pollutants or hazardous substances.

### BACKGROUND OF THE INVENTION

The concentration of one or more fluid substances (i.e. gases or liquids) within a sample can be determined via optical absorption spectroscopy, by passing light through the sample and detecting the optical absorption characteristics of those substances.

The amount of light absorbed by the substance and therefore the sensitivity of the method depends on the concentration of the substance and the path length of light through the substance. In gases, the concentration in terms of molecules per unit volume is generally much lower than in liquids or solids and therefore the path length of the light through the sample must be correspondingly higher. For example, the required path length is typically between about 2 m and 100 m for gas mixtures containing low concentrations of the target gases, such as atmospheric pollutants. This large path length can be achieved either by placing the light source and the detector far apart or by reflecting the light backwards and forwards through a sample in a measurement cell so that it passes through the sample numerous times before reaching the detector.

The utilisation of a multi-pass measurement cell can therefore provide a significant path length in an apparatus having a compact form. An example of a multi-pass measurement cell is the White cell. The basic White cell is a multi-reflection system conceived by J. U. White and initially published in “Long Optical Paths of Large Aperture”, Journal of the Optical Society of America, May 1942.

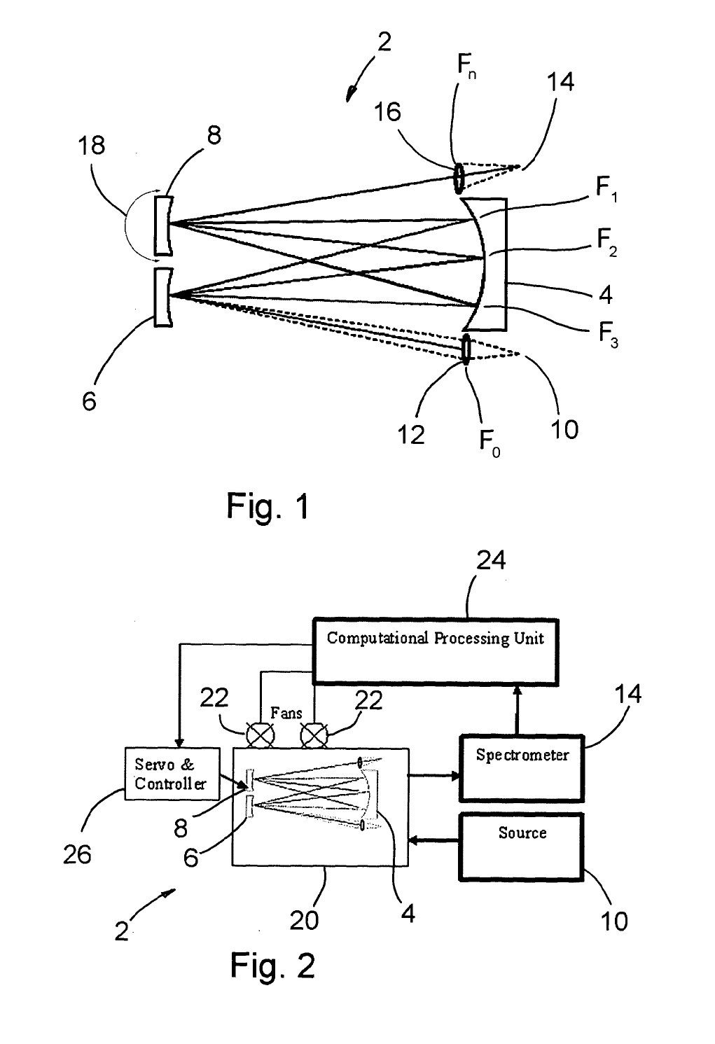

The White cell consists of three concave mirrors of identical radius of curvature, the basic configuration of which can be seen in FIG. 1. The front (or field) mirror faces the two side-by-side back (or objective) mirrors, the distance between the two sets of mirrors being twice their focal length. Light from a source at a point F₀ adjacent one edge of the front mirror is focused by the first back mirror onto the surface of the front mirror at point F₁. The front mirror is oriented such that it reflects the light towards the second back mirror, which refocuses the light at point F₂ on the front mirror. This light is then refocused by the first back mirror at point F₃, and so on thus forming two sets of foci F₁, F₃, F₅, . . . and F₂, F₄, F₆, . . . across the surface of the front mirror. Eventually, after n passes, the light reflected by the second back mirror falls off one side of the front mirror at focal point Fₙ and is collected by a detector. This light is then analysed by a spectrograph to detect the optical absorption spectra of the substances through which the light has passed.

As will be apparent from the description above, the light from the source is repeatedly refocused such that the effects of divergence over a long path length are minimised. Such divergent effects are typical from non-point sources of light and non-ideal collimation assemblies: this makes the White cell particularly useful for arc-based lamps. The White cell is the preferred multi-pass optical cell, although many practical alternatives exist such as Herriot cells, passive resonators, integrating spheres, etc.

Typically a White cell comprises a larger field mirror, with two smaller adjustable objective mirrors at some distance away. These mirrors optionally have adjustable pitch and yaw. Both the yaw and pitch are used to align the White cell to ensure that light reaches the detector from the source. The yaw adjustment controls the direction of the light path in the lateral plane and the pitch adjustment controls the direction of the light path in the perpendicular plane (also referred to herein as the vertical plane).

A significant consideration of the assembly of a White cell is in terms of mechanical rigidity. Due to the optical arrangement of the White cell, the cell is more robust to bending moments parallel to the vertical plane of the cell. This is because any deflection of the light path is compensated for equally and oppositely by the odd number of reflections on the field mirror. In the lateral plane, bending of the instrument can have more significant impact on the optical alignment.

The first back mirror (i.e. the one the light comes into contact with first), has its yaw arranged such that the reflected light incidences on a point on the front mirror furthest from the initial input. The pitch of both back mirrors is typically set such that the light entering and exiting the White cell remains on the same plane. Once the White cell is set up, only the yaw angle (herein termed φ) of the second back mirror is required to be adjusted to allow for a varying numbers of passes to be achieved. The number of passes can be characterised by a 2(n+1) relationship, where n is the number of beam incidence on the front mirror.

Conventionally, yaw adjustment on the second back mirror of a White cell is made prior to measurement, either for optimisation or for changing the sensitivity of the device prior to measurement by setting the number of passes.

The concentration of a particular substance in a sample can be determined from the absorbance of light by the substance. According to the Beer-Lambert law, the absorbance is directly proportional to the concentration of the substance and the path length of the light passing through the sample, the relationship being represented by:

$$A = - {log}_{10} ( \frac{I}{{I}_{0}} ) = ɛ . c . L$$

where A is the absorbance, I₀ is the intensity of the incident light at a given wavelength, I is the intensity of the transmitted light, ε is a constant (the extinction coefficient), c is the concentration of the substance and L is the path length. Therefore, for a fixed path length the transmitted light intensity is proportional to the concentration. The concentration can thus be determined by measuring I and I₀.

The incident intensity I₀ is measured by flooding the measurement cell with a non-absorbing fluid, for example nitrogen in the case of gas analysis. This means that a supply of a suitable fluid must be available whenever a zero reading is required. This may cause difficulties, particularly when measurements are made in the field. If a non-absorbing fluid is unavailable or zeroing is impractical, zeroing errors may result.

Another potential problem is that at high concentrations, where the absorbance approaches 100%, the Beer-Lambert relationship breaks down resulting in an inaccurate (low) concentration reading.

Where a CCD (charge coupled device) sensor is used to detect the transmitted light, further inaccuracies can be caused by pixel variations within the detector.

It is an object of the present invention to provide an apparatus for optical absorption spectroscopy and a method of optical absorption spectroscopy that mitigates at least some of these disadvantages.

U.S. Pat. No. 4,291,988 discloses an automated path differencing system in which measurements of atmospheric constituents can be made in a multi-pass cell by alternating between a short pathlength and a long pathlength.

U.S. Pat. No. 7,288,770 discloses a portable air monitoring system using UV spectroscopy capable of detecting chemicals in the open atmosphere or in a sample of air that is introduced into the measurement chamber of a White cell. The sensitivity and accuracy of the system is enhanced by collecting a full spectrum of data points and using multiple mirrors to provide a long beam path in a closed-path length.

U.S. Pat. No. 5,838,008 discloses the use of a White cell for the determination of gas concentrations via FTIR (Fourier transform infrared) spectroscopy.

U.S. Pat. No. 6,748,334 discloses a gas analysis system based on a White cell.

According to one aspect of the present invention there is provided an optical absorption spectroscopy apparatus comprising a light source, a detector for detecting an optical absorption spectrum of light transmitted from the source through a sample volume, one or more reflectors for reflecting the transmitted light multiple times through the sample volume, and a driven adjuster device for adjusting at least one adjustable optical element so as to vary the path length of the transmitted light by controlling the number of times the light is reflected through the sample volume, said driven adjuster device being constructed and arranged to drive the adjustable optical element continuously or quasi-continuously through a range of adjustment settings that correspond to different path lengths, and the detector being configured to detect the transmitted light continuously or quasi-continuously while the adjustable optical element is adjusted, so enabling the detector to detect variations in the transmitted light throughout the range of adjustment settings.

By detecting the transmitted light at a range of different path lengths it is possible to provide an artificial zero point without the need to flood the sample volume with a non-absorbing fluid, thus allowing for auto-calibration of the apparatus. The fast comparison between short and long path lengths also allows for differential path length analysis. The sensitivity of the apparatus can also be selected dynamically according to the concentration of the target fluid in the sample. This also allows for the simultaneous analysis of mixtures of target fluids at high and low concentrations.

By driving the adjustable optical element continuously or quasi-continuously through a range of adjustment settings that correspond to different path lengths, and configuring the detector to detect the transmitted light continuously or quasi-continuously while the adjustable optical element is adjusted, it is possible to detect maxima in the transmitted light intensity as the maxima are scanned across the detector. This improves the accuracy of the apparatus and reduces errors caused by optical misalignment.

The term “continuously or quasi-continuously” as used herein is intended to encompass arrangements in which the adjustable element is configured to be adjusted either continuously (that is, in a smooth movement, for example at a uniform speed) or quasi-continuously (that is, so that its movement is equivalent to a continuous movement). A quasi-continuous adjustment may be achieved, for example, by adjusting the movement in a series of small steps, as may be achieved for example by driving the adjustment with a stepper, cam, or servo motor (whether continuous rotation or discrete position). However, in the case of a quasi-continuous adjustment, these step-like adjustments must be carried out at a sufficiently frequent rate to provide an outcome that is equivalent to a continuous adjustment. Feedback on light intensity from the spectrometer helps govern the position (i.e. in recognising optimum light-throughput positions or number of passes), and in a preferred embodiment is an integral feature of operation. Precision of adjustment should be high enough to allow for this to take place, where between passes adjustment can be continuous or discrete in nature.

What constitutes a “sufficiently frequent rate” will depend on the circumstances in which the system is operating. Some illustrative examples of what constitutes a sufficiently frequent rate include, but are not limited to, the following cases,

1. In the case where the method is being used to correct for drift (providing a zero point), the adjustments must be made sufficiently frequently to minimise the drift and to keep accuracy high.

2. In the case where the method is being used to determine gas concentration, the adjustment rate must be sufficiently frequent for gas concentration not to vary or to be assumed to vary only linearly or in a predictable manner.

3. In the case where the method is being used to switch between different concentration ranges (e.g. between ppb and ppm), where the gas concentration measured warrants a change in path length, the adjustments must be made sufficiently frequently to keep the system in a linear mode of response.

4. In the case where the method used is to maintain optical alignment, the adjustments must be made sufficiently frequently to identify where light intensity has dropped and misalignment has occurred.

5. In the case where an absorbing gas species only has broader absorption features, the adjustments must be made sufficiently frequently to indicate that a broad analysis method is required.

The adjustable optical element may be a reflector or any other optical element (for example a refractive element) that is capable of affecting the path of the light and the number of times it is reflected across the sample volume.

The driven adjuster device may consist of a separate drive means and the adjuster means, for example comprising a drive motor and an adjuster screw. Alternatively, the driven adjuster device may consist of a single transducer device.

Advantageously, the apparatus comprises a White cell having a front mirror and first and second back mirrors. The adjuster device may be arranged to adjust the angular position of at least one of the mirrors. Preferably, the adjuster device adjusts the yaw angle of the second back mirror.

Adjusting the angle of the mirror allows for optimisation of the throughput of light to the detector. It is also possible to remove light from detector without needing to shutter or turn off the light source, thus allowing the dark field and the effects of scattering to be assessed.

The driven adjuster device is constructed and arranged to drive the adjustable optical element continuously or quasi-continuously. For example, the drive means may be a motor that drives the adjuster at a constant speed, or a stepper motor that drives the adjuster so that it adjusts the optical element in a number of discrete steps.

The apparatus may include a measurement cell for containing a sample fluid, which preferably includes fluid transfer means for transferring a sample fluid to and from the measurement cell. Alternatively, it may be preferable in some circumstances to use an open apparatus that monitors ambient fluids.

The apparatus preferably includes an analyser means that is constructed and arranged to analyse optical absorption characteristics of a sample fluid in the sample volume by recording and analysing variations in the detected light with variations in the path length.

Advantageously, the analyser is constructed and arranged to analyse the relationship between the absorption characteristics of a sample fluid and the path length of the transmitted light. The analyser is preferably constructed and arranged to determine a zero absorption value by extrapolating from measured absorption values. The analyser may be constructed and arranged to analyse the optical absorption characteristics of a sample fluid by differential analysis.

The apparatus may include a controller for controlling the driven adjuster device. The controller may also control other factors affecting operation of the apparatus, for example the flow of sample fluid through the sample volume, and environmental factors such as temperature, pressure and humidity.

Preferably, the apparatus is constructed and arranged for analysing the optical absorption characteristics of a gas. However, it may also be designed for analysing liquids.

The apparatus is preferably constructed and arranged for analysing the ultraviolet or ultraviolet-visible optical absorption characteristics of a sample fluid. Alternatively, it may be designed for analysing optical absorption spectra in the visible or infrared spectral regions.

Advantageously, the driven adjuster is configured to drive the adjustable optical element through a range of adjustment settings that correspond to three or more different path lengths. Obtaining readings at three or more different path lengths allows the analyser to identify non-linearities in the relationship between pathlength and intensity and thus avoid inaccuracies caused by non-linearities in the Beer-Lambert law.

According to a preferred embodiment of the invention there is provided a system for measuring one or more components of a fluid through the physical interaction of the fluid and light transmitted through the fluid, wherein the total path length of light transmitted through the fluid can be varied dynamically.

Preferably, the fluid is contained in a multi-pass measurement cell. Advantageously, the multi-pass measurement cell is a White cell where one or more mirrors are dynamically adjusted such that the path length changes.

The dynamic measurement of absorption through the multi-pass cell is preferably used to determine the zero reading of the system through differential analysis.

The zero and gradient of absorption over a number of path lengths, relative to path length, may be used to determine the concentration of the measured component and other systematic measurements of the device

Preferably, the light transmitted through the fluid is in the UV or UV-Visible regions of the spectrum.

Advantageously, the system corrects for internal environmental states such as temperature, flow rate, pressure and humidity, which are measured simultaneously in the cell. The flow of gas is optionally controlled during calibration processes and operation.

Advantageously, the system corrects for systematic effects such as reflectivity and scattering, and combines the measurements of differential and non-differential spectroscopic methods to enable improved measurements.

Advantageously, the system dynamically selects the path length and thereby adjusts the sensitivity based on the concentration of one or more fluid species being measured.

According to another aspect of the invention there is provided a method of measuring one or more components of a fluid by optical absorption spectroscopy, comprising reflecting light multiple times through a fluid in a sample volume, driving an adjustable optical element continuously or quasi-continuously through a range of adjustment settings to change the number of times the light is reflected and the path length of the light transmitted through the fluid, detecting the transmitted light continuously or quasi-continuously while the adjustable optical element is driven through the range of adjustment settings, detecting variations in the transmitted light with changes in the adjustment settings and analysing the optical absorption spectra of the transmitted light at a plurality of different path lengths, and determining the concentration of one or more components of the fluid from changes with path length in the optical absorption spectra.

The method preferably includes reflecting the transmitted light with one or more mirrors and varying the path length by adjusting at least one of the mirrors.

The method preferably includes passing the light through the fluid using a White cell.

The method preferably includes containing the fluid in a measurement cell.

The method preferably includes detecting variations in the transmitted light with changes in the adjustment settings and analysing the optical absorption spectra of the transmitted light at three or more different path lengths.

In preferred embodiments, the present invention relates to a set of methodologies that are possible when the measurement cell allows for the automated mechanical adjustment of the yaw of the second objective mirror such that several analytical procedures for accurate gas/liquid analysis can be completed dynamically. In preferred embodiments, the invention also relates to a multi-pass measurement cell configured for use in such methodologies.

An embodiment of the present will now be described by way of example with reference to the accompanying drawings, in which:

FIG. 1 is a plan view showing the optical arrangement of a standard White cell;

FIG. 2 is a schematic diagram of an apparatus for optical absorption spectroscopy according to an embodiment of the invention;

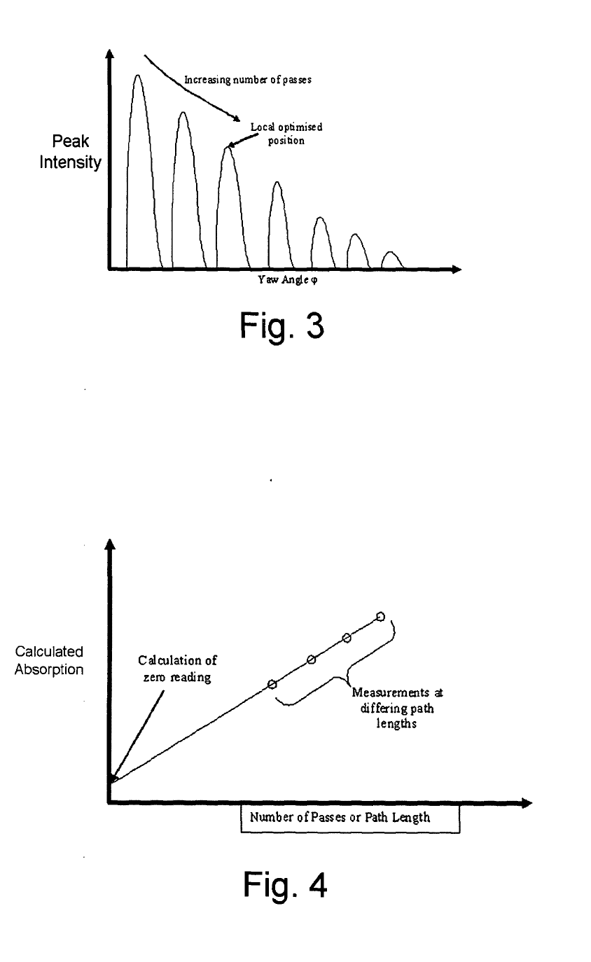

FIG. 3 is a graph showing a relationship between the intensity of light reaching a detector and the yaw angle of the second objective mirror in an apparatus as shown in FIG. 2, and

FIG. 4 is a graph showing a relationship between the calculated absorption and the number of passes or path length in an apparatus as shown in FIG. 2.

The optical arrangement of a standard White cell 2 is illustrated schematically in FIG. 1. The White cell 2 consists of three concave mirrors of identical radius of curvature: a front (or field) mirror 4, which faces two side-by-side back (or objective) mirrors 6,8. Usually, the mirrors are mounted within a measuring chamber (not shown) having inlet and outlet ports allowing a sample fluid (gas or liquid) to be introduced into and removed from the chamber. In an instrument for analysing gas samples, the distance between the front and back mirrors 4,6,8 is typically approximately 80 cm (although larger and smaller instruments can also be designed).

A light source 10, for example a Xenon arc lamp, having a source lens 12 is located adjacent one edge of the front mirror 4. Preferably, the light source 10 is a broadband source providing light in the ultraviolet (UV) or ultraviolet-visible (UV-Vis) spectral regions, although it may alternatively be an infrared (IR) source.

A detector 14 with an associated detector lens 16 is located adjacent the opposite edge of the front mirror 4. The detector 14 may for example be a CCD detector with an associated diffraction grating (not shown) that selects the wavelengths of light sensed by the detector. The detector 14 may be located in the vicinity of the front mirror 4 or alternatively it may be located remotely to receive light via an optical transfer device (not shown), for example an optical fibre. This light is then analysed by a spectrograph to detect the optical absorption spectra of the substances through which the light has passed.

The distance between the front mirror 4 and the two back mirrors 6,8 is twice the focal length of the mirrors, so that light from the source 10 is repeatedly refocused on the front mirror. In this example, light from the source 10 is focussed by the first back mirror 6 onto the surface of the front mirror at point F₁. The front mirror 4 is oriented such that it reflects the light towards the second back mirror 8, which refocuses the light at point F₂ in the centre of the front mirror 4. This light is then refocused by the first back mirror 6 at point F₃, and finally this light is reflected by the second back mirror 8 onto the detector 14. Therefore, in this example, the light traverses the chamber eight times, providing a path length that is eight times the distance between the front and back mirrors.

A White cell normally includes an adjustment mechanism such as a screw for manually adjusting the yaw angle φ of the second back mirror 8, by rotating the mirror about an axis that is perpendicular to the lateral plane of the instrument (the plane in which the axes of the source 10 and the detector 14 are located). In FIG. 1, the yaw adjustment is represented by the broken arrow 18. By adjusting the yaw angle, the number of reflections (and therefore the path length) of the light can be varied. This allows the sensitivity of the instrument to be controlled: for low concentrations of the target substance a high sensitivity can be obtained by adjusting the yaw angle to provide a large number of reflections and a long path length. For high concentrations of the target substance when a lower sensitivity is required, the yaw angle can be adjusted to provide a lower number of reflections and a shorter path length. The appropriate path length is normally decided in advance, based on the expected range of concentrations of the target substance.

The yaw angle can also be finely adjusted to ensure that the transmitted light is directed accurately along the axis of the detector 14, for maximum sensitivity. Unfortunately, owing to the sometimes large number of internal reflections and the long path length, the instrument is highly sensitive to alignment errors, which can have a significant impact on the accuracy and sensitivity of the instrument. Alignment errors can also be caused by mechanical strains acting on the apparatus during use. In a conventional operating process, the yaw angle of the mirror is normally adjusted before taking a measurement, or between measurements: it is not adjusted during a measurement.

An apparatus for optical absorption spectroscopy according to an embodiment of the invention is shown schematically in FIG. 2. The apparatus, which in this example is designed for analysing gas samples, includes a White cell 2 that is housed within a measurement chamber 20. Two fans 22 are provided to introduce and extract a gas sample through associated inlet and outlet ports (not shown). The fans 22 are connected to a computational processing unit (CPU) 24 that controls their operation automatically or in response to control signals from an operator.

The spectroscopy apparatus includes a mechanical actuator 26 linked to the second back mirror 8 for adjusting the yaw angle of the mirror. This actuator 26 may for example be a servo motor with an associated controller, or a stepper motor, or any other actuator capable of rotating the mirror continuously or quasi-continuously through a range of yaw angles. The actuator 26 is connected to the CPU 24, which controls its operation automatically or in response to control signals from an operator.

The detector 14 (a spectrometer) is also connected to the CPU 24 and delivers to the CPU a signal representing the intensity of the detected light. Optionally, the light source 10 may also be connected to the CPU 24 so that it can be controlled by the CPU.

In operation, a sample is introduced into the measurement chamber 20, and the light source 10 and the detector 14 are actuated. Transmitted light intensity readings are delivered continuously or quasi-continuously from the detector 14 to the CPU 24 where they are recorded for analysis. While these transmitted light intensity readings are being recorded or analysed, the actuator 26 adjusts the yaw angle of the second back mirror 8. As this angle changes, the number of times the light is reflected between the front and back mirrors before it falls off the edge of the front mirror changes. The path length therefore increases or decreases in steps, where each step is equal to four times the separation between the front mirror 4 and the back mirrors 6,8. The apparatus therefore obtains a series of intensity measurement in rapid succession at different path lengths.

Another effect of adjusting the yaw angle of the second back mirror 8 is that the angle of the transmitted beam falling off the edge of the front mirror 4 changes as the mirror rotates. The transmitted beam is therefore scanned across the aperture of the detector 14. As a result, the intensity of the transmitted light reaching the detector 14 as the yaw angle φ changes consists of a series of peaks of varying intensity, as shown in FIG. 3. The peaks decrease in magnitude as the yaw angle φ and the path length increase, owing to the increased absorption of the light with increased path length. Between the peaks, there are points where the transmitted beam does not fall on the detector aperture, resulting in no detection. However, because the transmitted beam is scanned across the aperture of the detector, for each peak there is a point of maximum intensity, when the beam is perfectly aligned with the detector. Therefore, problems caused by misalignment resulting from external forces acting on the instrument are avoided.

Furthermore, by sensing the variation in intensity and correlating this against the yaw angle, feedback can be obtained with regard to the optimum mirror position, which can subsequently be used to set the mirror position.

In addition, by setting the mirror to an angle in which no light reaches the detector, it is possible to measure the dark field and any scattering effects, without having to shutter or switch off the lamp.

Taking a number of readings of transmitted light intensity at different path lengths makes it possible to plot the calculated absorption of the sample against path length, as shown in FIG. 4. It is then possible to determine by extrapolation the absorption value at a zero path length. This avoids the need to obtain a zero measurement, for example by flooding the measuring chamber with a non-absorbing fluid.

The absorption value at zero path length should of course be zero, since at zero path length there should be no absorption. However, in practice zeroing errors can occur as discussed above. The method provides compensation for these zeroing errors.

Furthermore, the gradient of the line representing the variation of absorption with path length can be determined and compared at a number of different path lengths. Any significant change in gradient as shown for example at A in FIG. 4 may represent a region in which the relationship is no longer linear as required by the Beer-Lambert law. This may happen for example at high a concentration of the target fluid, when the absorption may approach 100%. If measurements are made at three or more different pathlengths, non-linear regions of the relationship can be identified. By ignoring these non-linear regions and obtaining concentration values using only the linear region of the plot a more accurate measurement of concentration can be obtained.

Obtaining a larger number of readings also improves the accuracy of concentration calculations made using the method. To this end, repeated measurements may be taken, for example by scanning back and forth through a range of different pathlengths. This is typically performed at a sufficiently frequent rate, that being a rate sufficient for the light adjustment to change faster than significant gas concentration changes in the cell. By changing the light path faster than significant gas changes, and faster than other systematic variations, methods of light analysis disclosed here can be used to yield more information about the gas content.

In addition, differential path length analysis of the sample can be performed by comparing the absorption spectra at short and long path lengths.

A method for calculating the concentration of a target substance in a sample will now be described in more detail.

In the application of ultraviolet (UV) spectroscopy, the broadband light passing through fluid in the cell is analysed for spectral absorption signatures. For limited amounts, the absorption of light is governed by Beer-Lambert wherein:

$$T ( λ ) = \frac{I ( λ )}{{I}_{0} ( λ )} = {e}^{- Lc σ ( λ )}$$

Where T(λ) is transmission with respect to wavelength λ, I(λ) is light intensity after passing through the fluid, I₀(λ) is light intensity entering the fluid, L is path length, c is the concentration of absorbing fluid species (i.e. the number density of molecules), and σ(λ) is the intrinsic absorption cross section of the fluid. Likewise

$$D ( λ ) = ln \frac{I ( λ )}{{I}_{0} ( λ )} = - Lc σ ( λ )$$

in terms of absorbance D, and in particular:

$${D}^{′} ( λ ) = ln \frac{I ( λ )}{{I}_{0}^{′} ( λ )} = - L {\sum }_{i = 1}^{K} {c}_{i} {σ}_{i}^{′} ( λ )$$

when many (K) species absorb about a differential spectrum (i.e. one in which only features that vary rapidly with respect to wavelength are considered). I′₀(λ) is the intensity in the absence of differential absorption, which can be approximated numerically.

One aspect of the invention concerns a methodology which comprises the automated mechanical variation of path length in a multi-pass measurement cell, such that a methodology for accurate analysis can be completed dynamically. This may be achieved for example by adjusting the yaw of the second mirror of a White cell. Mechanical adjustment may be achieved by the inclusion of a position-based or continuous motion servo motor, although other types of motor (such as stepper motors) are equally suitable.

Another aspect of the invention relates to a multi-pass measurement cell (for example a White cell) that is configured for use in such a method.

The servo is mounted on the rear of the White cell external to the fluid chamber, and interacts with the second objective mirror mounting. Fine adjustment is made via a fine-pitch thread or differential screw. Such adjustment is able to rapidly scale up and down the path length on-the-fly, thus varying the amount of fluid in the White cell exposed to the UV light.

Such arrangement is used then:

1. To provide optical optimisation of light throughput by adjustment of the light path in the lateral plane. Such arrangement makes use of the fact that the spectrometer is used to measure the light intensity simultaneously against any adjustment, thereby providing feedback as to the optimum mirror position. FIG. 3 illustrates how the peak light intensity could vary with yaw angle.

2. To remove light from the path without the need for a shutter in order to determine the so-called dark field and/or scattered light in its effect on the spectrometer without the need to turn off or shutter the lamp.

3. To provide an artificial zero point through the correlation of multiple path lengths without the need to flood the chamber with a non-absorbing species (such as nitrogen in the case of gas analysis). Such auto-calibration significantly improves the robustness of the unit in the field. The continuation (extrapolation) of points allows the prediction of absorption at zero path length, i.e. the background absorption. Determination of background absorption helps greatly with correction of the lower detection limit. Additionally it would allow for the removal of non-log-linear artefacts from correlation over multiple path lengths. FIG. 4 illustrates this conceptually.

4. The fast correlation between a low number of passes and high number of passes (i.e. short path length vs. long path length), allows for differential path length analyses to take place. To ensure that an unvarying gas/liquid concentration is present in the cell during the analysis, any pumps or fans can be inhibited in operation during this time. Since the concentration of gas/liquid in the cell is expected to change at a slower rate than the response time of the servo (and sampling period) or analysis process, this type of calibration can take place on-the-fly with gas/liquid in the cell. Other effects such as temperature-based variations of background calibrations (i.e. pixel sensitivities, UV-source lamp features) are also expected to change more slowly than the analysis process. This is a useful technique since it removes the need for zero or span calibration requirements. Overall these methods build further on techniques such as DOAS (differential optical absorption spectroscopy), which are an absolute measure of concentration already with minimal need for calibration.

These can take place in two forms:
a. The comparison of the differential spectra for two different numbers of passes m and n which differ in length by ΔL , A′ₘ(λ) vs. A′ₙ(λ), which in narrow-band terms should only be on account of the additional gas/liquid absorption over the increased path length.

$$\frac{{D}_{m}^{′} ( λ )}{{D}_{n}^{′} ( λ )} = - Δ Lc {σ}^{′} ( λ )$$

where one absorber is present, or

$$\frac{{D}_{m}^{′} ( λ )}{{D}_{n}^{′} ( λ )} = - L {\sum }_{i = 1}^{K} {c}_{i} {σ}_{i}^{′} ( λ )$$

where K absorbers are present.
b. The comparison of the complete absorption spectra (i.e. broad and narrow features), for conventional UV spectroscopy for broadband absorbers. In conventional analysis, narrow-band backgrounds such as pixel sensitivity can be separated from broad-band correction against mirror reflectivity via the use of a low-pass filter, or through the use of a neutral density filter. Such a technique is particularly useful for heavily-broadband gas/liquid absorbers (such as ozone in the gas phase). Moreover it is most useful where a species has both narrow and broad features. Where,

$$Δ T ( λ ) = \frac{{I}_{m} ( λ )}{{I}_{n} ( λ )} = {e}^{- Δ Lc σ ( λ )}$$

corresponding to the difference in intensities between two different path lengths. Here we assume that any Rayleigh and Mie scattering effects are either negligible or factored out numerically. Furthermore, it can be shown that the broad intercept of a series of absorbance lines is:

$$D ( λ ) = ln \frac{{I}_{n} ( λ )}{{I}_{0} ( λ )} = [ f ln ( R ( λ ) ) - σ ( λ ) c ] \cdot L + ln ( R ( λ ) )$$

Where f is used to relate the number of passes to total path length. As such;

$$\frac{d D ( λ )}{d L} = f ln ( R ( λ ) ) - σ ( λ ) c$$

Given that the reflectivity curve

D(λ)=ln(R(λ))
can be determined from the intercept of a series of varying-path length absorption spectra (or pre-measured), the same curve can be used to correct the broadband absorptions of

$$\frac{d D ( λ )}{d L}$$

used to determine concentrations.

5. Through the combination of 4a and 4b, wavelength-region and species-based weighed determination of concentration can be achieved through statistical fitting such as partial least squares analysis, where mixtures consist of fluid species with narrow and/or broad-band features. Weightings can be determined prior to measurement based on the local wavelength region and the number of characteristic narrow-band features.

6. The sensitivity of the device can be selected dynamically, depending on the concentrations being measured. This allows for avoidance of running into the non-linear region of Beer-Lambert—i.e. at concentrations measured in parts per million (ppm) or parts per billion (ppb). This technique is also useful where a mixture of high concentration and low concentration species are present in the same sample.

In summary, preferred embodiments of the invention provide apparatus and systems methodology, preferably using UV spectroscopy, for the dynamic and continuous detection and quantification of a range of chemicals, particularly pollutants, in the environment. The invention provides for the automatic mechanical adjustment of a White cell and the accompanying analysis methods are used to improve the performance of quantitative measurement of the concentration of one or more fluids present in the gas/liquid analysis chamber. Methods employed include optimisation, zero point measurement, and extensions to both differential and conventional optical absorption spectroscopy.

Embodiments of the invention provide apparatus and systems methodology, preferably using UV spectroscopy, for the dynamic and continuous detection and quantification of a range of chemicals, particularly pollutants, in the environment. Embodiments of the invention may be characterised by the automatic mechanical adjustment of White cell and the accompanying analysis methods used to improve the performance of quantitative measurement of the concentration of one or more fluids present in the gas/liquid analysis chamber. Methods employed include optimisation, zero point measurement, and extensions to both DOAS and conventional absorption spectroscopy.

1. Optical absorption spectroscopy apparatus comprising a light source, a detector for detecting an optical absorption spectrum of light transmitted from the source through a sample volume, one or more reflectors for reflecting the transmitted light multiple times through the sample volume, and a driven adjuster device for adjusting at least one adjustable optical element so as to vary the path length of the transmitted light by controlling the number of times the light is reflected through the sample volume, said driven adjuster being configured to drive the adjustable optical element continuously or quasi-continuously through a range of adjustment settings that correspond to different path lengths, and the detector being configured to detect the transmitted light continuously or quasi-continuously while the adjustable optical element is adjusted, so enabling the detector to detect variations in the transmitted light throughout the range of adjustment settings.

2. An apparatus according to claim 1, the apparatus comprising a White cell having a front mirror and first and second back mirrors.

3. An apparatus according to claim 2, in which the adjuster device is arranged to adjust the angular position of at least one of the mirrors.

4. An apparatus according to claim 1, further comprising a measurement cell for containing a sample fluid.

5. An apparatus according to claim 4, including fluid transfer means for transferring a sample fluid to and from the measurement cell.

6. An apparatus according to claim 1, further comprising an analyser that is configured to analyse optical absorption characteristics of a sample fluid in the sample volume by analysing variations in the detected light with variations in the path length.

7. An apparatus according to claim 6, in which the analyser is configured to analyse a relationship between the absorption characteristics of a sample fluid and the path length of the transmitted light.

8. An apparatus according to claim 7, in which the analyser is configured to determine a zero absorption value by extrapolating from measured absorption values.

9. An apparatus according to claim 6, in which the analyser is configured to analyse the optical absorption characteristics of a sample fluid by differential analysis.

10. An apparatus according to claim 1, further comprising a controller for controlling the driven adjuster device.

11. An apparatus according to claim 1, wherein the apparatus is configured for analysing the optical absorption characteristics of a gas.

12. An apparatus according to claim 1, wherein the apparatus is configured for analysing the ultraviolet or ultraviolet-visible optical absorption characteristics of a sample fluid.

13. An apparatus according to claim 1, wherein the driven adjuster is configured to drive the adjustable optical element continuously or quasi-continuously through a range of adjustment settings that correspond to three or more different path lengths.

14. A method of measuring one or more components of a fluid by optical absorption spectroscopy, comprising:
a. reflecting light multiple times through a fluid in a sample volume;
b. driving an adjustable optical element continuously or quasi-continuously through a range of adjustment settings to change the number of times the light is reflected and the path length of the light transmitted through the fluid;
c. detecting the transmitted light continuously or quasi-continuously while the adjustable optical element is driven through the range of adjustment settings;
d. detecting variations in the transmitted light with changes in the adjustment settings and analysing the optical absorption spectra of the transmitted light at a plurality of different path lengths, and
e. determining the concentration of one or more components of the fluid from changes with path length in the optical absorption spectra.

15. A method according to claim 14, including reflecting the transmitted light with one or more mirrors and varying the path length by adjusting at least one of the mirrors.

16. A method according to claim 14, including wherein said step of reflecting light multiple times through a fluid in a sample volume comprises passing the light through the fluid using a White cell.

17. A method according to claim 14, including containing the fluid in a measurement cell.

18. A method according to claim 14, including detecting variations in the transmitted light with changes in the adjustment settings and analysing the optical absorption spectra of the transmitted light at three or more different path lengths.

19. A method according to claim 15 wherein said step of reflecting light multiple times through a fluid in a sample volume comprises passing the light through the fluid using a White cell.

20. An apparatus according to claim 8, wherein the driven adjuster is configured to drive the adjustable optical element continuously or quasi-continuously through a range of adjustment settings that correspond to three or more different path lengths.
